(19) United States
(12) Patent Application Publication
(10) Pub. No.: US 2020/0384881 A1
(43) Pub. Date: Dec. 10, 2020

(54) INFORMATION PROVIDING APPARATUS, INFORMATION PROVIDING METHOD, AND PROGRAM

(71) Applicant: HONDA MOTOR CO., LTD., Tokyo (JP)

(72) Inventors: Mitsuteru Yano, Wako-shi (JP); Shinichi Yokoyama, Wako-shi (JP); Thomas Stephen Pontefract, Wako-shi (JP); Yusaku Amari, Wako-shi (JP)

(21) Appl. No.: 16/882,908

(22) Filed: May 26, 2020

(30) Foreign Application Priority Data
May 28, 2019 (JP) 2019-099362

(51) Int. Cl. B60L 53/66; B60L 53/68; B60L 58/12; G05D 1/02

(52) U.S. Cl. CPC B60L 53/665; G05D 1/0217; B60L 58/12; B60L 53/68

(57) ABSTRACT

An information providing apparatus includes: an acquisition part that acquires cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and a providing part that provides information in which the cost indicated by the cost data and the electric power purchase price indicated by the electric power purchase price data are associated with each other.

### CROSS-REFERENCE TO RELATED APPLICATION

Priority is claimed on Japanese Patent Application No. 2019-099362 filed on May 28, 2019, the contents of which are incorporated herein by reference.

### BACKGROUND

### Field of the Invention

The present invention relates to an information providing apparatus, an information providing method, and a program.

### Background

In recent years, the V2G (Vehicle to Grid) has been attracting attention as a technique for stabilizing an electric power system. The V2G is a technique that interchanges electric power between the electric power system and a battery mounted on a vehicle.

For example, Japanese Patent No. 6034198 describes a device including: a station communication port for connecting to an electric vehicle service equipment (EVSE); a vehicle communication port for connecting to a vehicle management system (VMS); and a processor connected to the station communication port and the vehicle communication port for establishing communication with the EVSE via the station communication port, receiving an EVSE attribute from the EVSE, and issuing a command to the VMS so as to manage an electric power flow between an electric vehicle and the EVSE on the basis of the EVSE attribute. This device connects to a grid by establishing communication with the EVSE, receives the EVSE attribute, and manages the electric power flow between an electric vehicle equipment (EVE) and the grid on the basis of the EVSE attribute.

### SUMMARY

However, the above-described device is a device that manages the electric power flow between the EVE and the grid, and is not a device that informs an EVE user of a charging and discharging stand that provides a high profit obtained by performing charging or discharging. Therefore, the above-described device cannot improve the efficiently of the V2G performed between the electric power system and the vehicle.

An object of an aspect of the present invention is to provide an information providing apparatus, an information providing method, and a program capable of supporting electric power interchange from which a vehicle user can benefit.

A first aspect of the present invention is an information providing apparatus including: an acquisition part that acquires cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and a providing part that provides information in which the cost indicated by the cost data and the electric power purchase price indicated by the electric power purchase price data are associated with each other.

A second aspect of the present invention is the information providing apparatus according to the first aspect described above, wherein the providing part may add at least one of a ranking of the cost and a ranking of the electric power purchase price to the information and provide the information.

A third aspect of the present invention is the information providing apparatus according to the first or second aspect described above, wherein the providing part may provide the information of the electric power purchase facility located at a position where a path from the position indicated by the vehicle position data is equal to or less than a predetermined length.

A fourth aspect of the present invention is the information providing apparatus according to the first to third aspects described above, wherein the information providing apparatus may further include a communication part that transmits the vehicle position data and receives the electric power purchase facility position data.

A fifth aspect of the present invention is an information providing method including: an acquisition step of acquiring cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and a providing step of providing information in which the cost indicated by the cost data and the electric power purchase price indicated by the electric power purchase price data are associated with each other.

A sixth aspect of the present invention is a non-transitory computer-readable recording medium including a program that causes a computer to implement: an acquisition function of acquiring cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and a providing function of providing information in which the cost indicated by the cost data and the electric power purchase price indicated by the electric power purchase price data are associated with each other.

According to the first to sixth aspects described above, since the information in which the cost required for the vehicle to move to the electric power purchase facility and the electric power purchase price at the electric power purchase facility are associated with each other is provided, it is possible to provide helpful information for making a decision when a user sells electric power stored in a battery mounted on the vehicle to the electric power purchase facility, and it is possible to support electric power interchange from which the vehicle user can benefit.

According to the second aspect described above, since at least one of the ranking of the cost and the ranking of the electric power purchase price is added to the information described above, and the information is provided, it is possible to add a relative merit on a predetermined point of view to the helpful information for making a decision when a user sells electric power stored in a battery mounted on the vehicle to the electric power purchase facility, and it is possible to provide the information in a form that is easy for the user to understand.

According to the third aspect described above, since the information described above of the electric power purchase facility located at a position where a path from the position indicated by the vehicle position data is equal to or less than a predetermined length is provided, it is possible to provide information about an electric power purchase facility to which the user can easily access.

### BRIEF DESCRIPTION OF THE DRAWINGS

FIG. 1 is a view showing an example of an electric power business operator server, an aggregator server, a vehicle, and an information providing apparatus according to a first embodiment.

FIG. 2 is a view showing an example of cost data and electric power purchase facility position data acquired by the information providing apparatus according to the first embodiment.

FIG. 3 is a view showing an example of information provided by the information providing apparatus according to the first embodiment.

FIG. 4 is a flowchart showing an example of a process performed by the information providing apparatus according to the first embodiment.

FIG. 5 is a view showing an example of an electric power business operator server, an aggregator server, a vehicle, and an information providing apparatus according to a second embodiment.

FIG. 6 is a view showing an example of an electric power business operator server, an aggregator server, a vehicle, and an information providing apparatus according to a third embodiment.

### DESCRIPTION OF THE EMBODIMENTS

Hereinafter, embodiments of an information providing apparatus according to the present invention will be described with reference to the drawings.

### First Embodiment

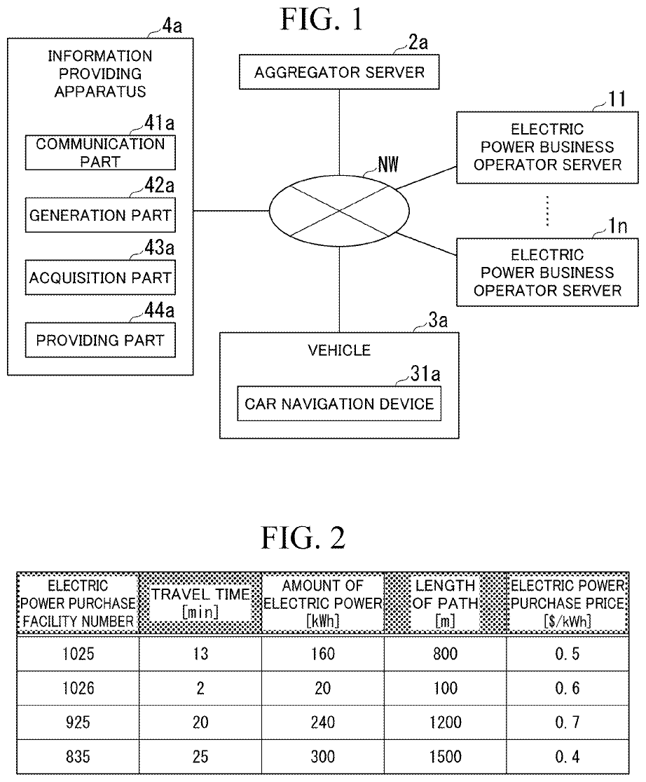

An information providing apparatus according to a first embodiment will be described with reference to FIG. 1 to FIG. 3. FIG. 1 is a view showing an example of an electric power business operator server, an aggregator server, a vehicle, and an information providing apparatus according to a first embodiment. As shown in FIG. 1, an electric power business operator server 11, . . . , an electric power business operator server 1n (n: a natural number equal to or more than two), an aggregator server 2a, a vehicle 3a, and an information providing apparatus 4a are connected to a network NW. The network NW is, for example, the Internet.

The electric power business operator server 11, . . . , the electric power business operator server 1n transmit electric power demand data indicating an amount of electric power, which is required by an electric power business operator that supplies electric power to an electric power system to be supplied to the electric power system, to the aggregator server 2a through the network NW at a predetermined timing. Further, each of the electric power business operator server 11, . . . , and the electric power business operator server 1n transmits the electric power demand data for one electric power business operator. Alternatively, each of the electric power business operator server 11, . . . , and the electric power business operator server 1n transmits the electric power demand data for two or more electric power business operators. The predetermined timing described above may be a periodic timing or may be an aperiodic timing.

The aggregator server 2a receives the electric power demand data at each predetermined time from each of the electric power business operator server 11, . . . , and the electric power business operator server 1n. The aggregator server 2a generates electric power purchase price data indicating an electric power purchase price in at least one electric power purchase facility on the basis of at least one electric power demand data. The electric power purchase price data is stored in a storage device provided inside or outside the aggregator server 2a. The electric power purchase facility is a facility that discharges or charges a secondary battery in order to interchange electric power between the electric power system and the secondary battery mounted on the vehicle 3a or the like. The electric power purchase price is, for example, a unit price of the amount of electric power supplied to the electric power purchase facility by the vehicle 3a.

The aggregator server 2a accesses electric power purchase facility position data indicating a position of the electric power purchase facility. The electric power purchase facility position data is, for example, data indicating a latitude and longitude of the position of the electric power purchase facility. The electric power purchase facility position data is stored in a storage device provided inside or outside the aggregator server 2a.

The vehicle 3a is a vehicle on which a secondary battery that stores electric power for traveling is mounted such as, for example, an EV (Electric Vehicle) or a HV (Hybrid Vehicle), and a car navigation device 31a is mounted on the vehicle 3a. The car navigation device 31a acquires vehicle position data indicating the position of the vehicle 3a, for example, using a GPS (Global Positioning System) or map matching. The vehicle position data is, for example, data indicating the latitude and longitude of the position of the vehicle 3a.

The information providing apparatus 4a includes, for example, a communication part 41a, a generation part 42a, an acquisition part 43a, and a providing part 44a. The communication part 41a, the generation part 42a, the acquisition part 43a, and the providing part 44a are implemented, for example, by a hardware processor such as a CPU (Central Processing Unit) executing a program or a software. Some or all of the functions of the information providing apparatus 4a may be implemented by hardware including circuitry such as an LSI (Large Scale Integration), an ASIC (Application Specific Integrated Circuit), a FPGA (Field-Programmable Gate Array), and a GPU (Graphics Processing Unit), or may be implemented by cooperation of software and hardware. The program may be stored in advance in a storage device including a non-transitory storage medium such as a HDD (Hard Disk Drive) or a flash memory, or may be stored in a removable non-transitory storage medium such as a DVD or a CD-ROM and installed by the storage medium being attached to a drive device.

The communication part 41a receives the vehicle position data from the vehicle 3a and receives the electric power purchase facility position data and the electric power purchase price data from the aggregator server 2a.

The generation part 42a generates cost data indicating a cost required for the vehicle 3a to move to the electric power purchase facility on the basis of the vehicle position data received by the communication part 41a and the electric power purchase facility position data received by the communication part 41a. Examples of the cost include a time required for the vehicle 3a to move from the present position to the electric power purchase facility, the amount of electric power, the amount of fuel, and a length of a path from the present position of the vehicle 3a to the electric power purchase facility. The cost may include a factor that affects the movement of the vehicle 3a from the present position to the electric power purchase facility such as a situation of traffic congestion on the path from the present position of the vehicle 3a to the electric power purchase facility or a situation of a road surface. The cost data is derived on the basis of at least the vehicle position data and the electric power purchase facility position data.

The acquisition part 43a acquires the cost data and the electric power purchase price data. Specifically, the acquisition part 43a acquires the cost data from the generation part 42a and acquires the electric power purchase price data from the communication part 41a.

FIG. 2 is a view showing an example of the cost data and the electric power purchase facility position data acquired by the information providing apparatus according to the first embodiment. The acquisition part 43a acquires, as the cost data, data in which an electric power purchase facility number that is a number specific to the electric power purchase facility is associated with, for example, a travel time shown in FIG. 2, the amount of electric power required to move to the electric power purchase facility, and the length of the path to the electric power purchase facility. The acquisition part 43a acquires, as the electric power purchase price data, data in which the electric power purchase price is associated with the electric power purchase facility number.

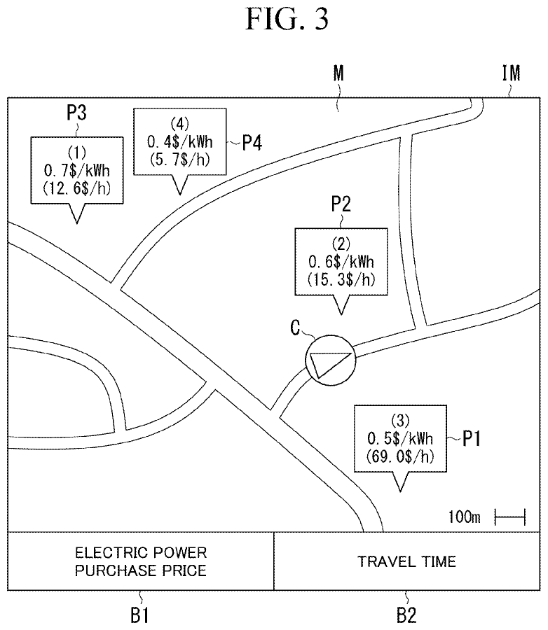

FIG. 3 is a view showing an example of information provided by the information providing apparatus according to the first embodiment. The providing part 44a provides information in which the cost indicated by the cost data and the electric power purchase price indicated by the electric power purchase price data are associated with each other. Specifically, the providing part 44a generates an image IM shown in FIG. 3 and transmits the image IM to the car navigation device 31a using the communication part 41a. In this case, for example, the image IM is displayed, for example, on a display mounted on the car navigation device 31a. Alternatively, the providing part 44a transmits data required for generating the image IM to the car navigation device 31a via the communication part 41a. In this case, the image IM is generated, for example, by the car navigation device 31a and displayed on the display mounted on the car navigation device 31a.

The providing part 44a, for example, displays the image IM shown in FIG. 3 on the display mounted on the car navigation device 31. The image IM includes a map M, an icon C, a word balloon P1, a word balloon P2, a word balloon P3, a word balloon P4, a button B1, and a button B2. The map M extracts the vehicle 3a and a road, a facility, and the like located in the vicinity of the vehicle 3a. The icon C shows the present position of the vehicle 3a.

The word balloon P1 shows a position and an electric power purchase price of an electric power purchase facility of which the electric power purchase facility number is “1025” shown in FIG. 2. The word balloon P1 shows that the order of the electric power purchase price is the third place among the electric power purchase facilities displayed in FIG. 2 and FIG. 3 by “(3)” at the first line from the top. The word balloon P2 shows a position and an electric power purchase price of an electric power purchase facility of which the electric power purchase facility number is “1026” shown in FIG. 2. The word balloon P2 shows that the order of the electric power purchase price is the second place among the electric power purchase facilities displayed in FIG. 2 and FIG. 3 by “(2)” at the first line from the top.

The word balloon P3 shows a position and an electric power purchase price of an electric power purchase facility of which the electric power purchase facility number is “925” shown in FIG. 2. The word balloon P3 shows that the order of the electric power purchase price is the first place among the electric power purchase facilities displayed in FIG. 2 and FIG. 3 by “(1)” at the first line from the top. The word balloon P4 shows a position and an electric power purchase price of an electric power purchase facility of which the electric power purchase facility number is “835” shown in FIG. 2. The word balloon P4 shows that the order of the electric power purchase price is the fourth place among the electric power purchase facilities displayed in FIG. 2 and FIG. 3 by “(4)” at the first line from the top.

Each of the word balloon P1, the word balloon P2, the word balloon P3, and the word balloon P4 shows that the number within the parentheses in the third line from the top is a value obtained by dividing a profit, which is obtained when the vehicle 3a sells the maximum amount of electric power, by a time required for moving to the electric power purchase facility. Further, since the map M, the scale of the map M, and the icon C are displayed by the image IM, the word balloon P1, the word balloon P2, the word balloon P3, and the word balloon P4 show the length of the path from the present position of the vehicle 3a to the electric power purchase facility.

The button B1 is a button pressed when the order of the electric power purchase price is displayed in the word balloon P1, the word balloon P2, the word balloon P3, and the word balloon P4. The button B2 is a button pressed when the order of the travel time to the electric power purchase facility is displayed in the word balloon P1, the word balloon P2, the word balloon P3, and the word balloon P4. FIG. 3 shows a case in which the order of the electric power purchase price is displayed by the word balloon P1, the word balloon P2, the word balloon P3, and the word balloon P4.

The providing part 44a may add at least one of a time, the amount of electric power, and the amount of fuel required for the vehicle 3a to move from the present position to the electric power purchase facility to the image shown in FIG. 3. The providing part 44a may display, on the display, an image equivalent to the image IM shown in FIG. 3 of an electric power purchase facility located at a position where a path from the position indicated by the vehicle position data is equal to or less than a predetermined length.

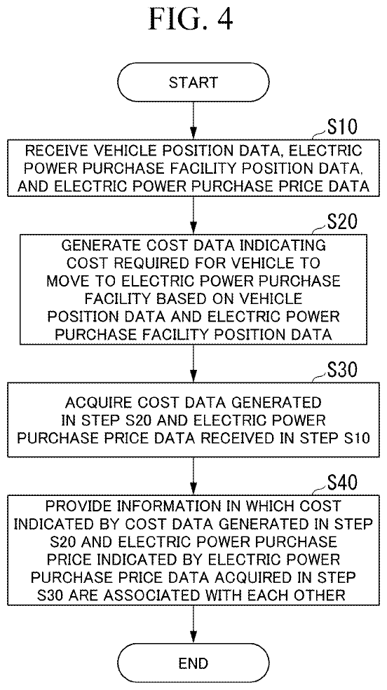

Next, a process performed by the information providing apparatus 4a according to the first embodiment will be described with reference to FIG. 4. FIG. 4 is a flowchart showing an example of a process performed by the information providing apparatus according to the first embodiment.

The communication part 41a receives the vehicle position data, the electric power purchase facility position data, and the electric power purchase price data (Step S10).

Next, the generation part 42a generates the cost data indicating the cost required for the vehicle 3a to move to the electric power purchase facility on the basis of the vehicle position data and the electric power purchase facility position data (Step S20).

Next, the acquisition part 43a acquires the cost data generated in Step S20 and the electric power purchase price data received in Step S10 (Step S30).

Next, the providing part 44a provides the information in which the cost indicated by the cost data generated in Step S20 and the electric power purchase price indicated by the electric power purchase price data acquired in Step S30 are associated with each other (Step S40).

The information providing apparatus 4a according to the first embodiment is described above. The information providing apparatus 4a acquires the cost data and the electric power purchase price data and provides the information in which the cost indicated by the cost data and the electric power purchase price indicated by the electric power purchase price data are associated with each other. Accordingly, the information providing apparatus 4a can provide helpful information for making a decision when a user sells electric power stored in a battery mounted on the vehicle 3a to the electric power purchase facility and support electric power interchange from which the user of the vehicle 3a can benefit.

The information providing apparatus 4a adds at least one of the ranking of the cost and the ranking of the electric power purchase price to the information described above and provide the information. Accordingly, the information providing apparatus 4a can add a relative merit on a predetermined point of view to the helpful information for making a decision when a user sells electric power stored in a battery mounted on the vehicle to the electric power purchase facility and provide the information in a form that is easy for the user to understand.

The information providing apparatus 4a provides the information described above of the electric power purchase facility located at a position where a path from the position indicated by the vehicle position data is equal to or less than a predetermined length. Accordingly, the information providing apparatus 4a can provide information about an electric power purchase facility to which the user of the vehicle 3a can easily access.

### Second Embodiment

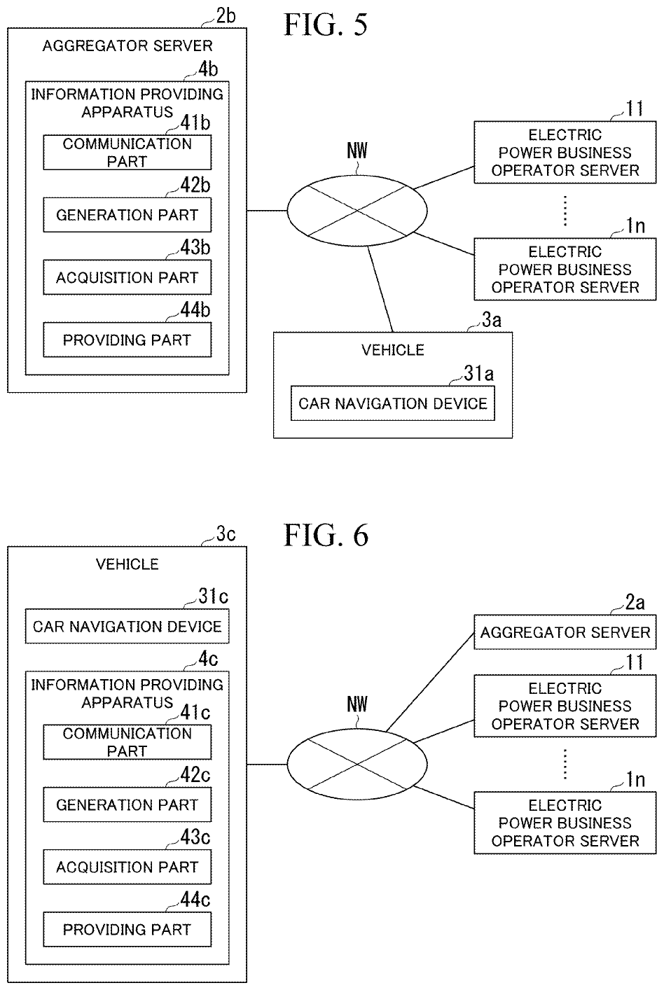

An information providing apparatus according to a second embodiment will be described with reference to FIG. 5. The information providing apparatus according to the second embodiment differs from the information providing apparatus 4a according to the first embodiment in that the information providing apparatus according to the second embodiment is not independent and is included in an aggregator server. Therefore, in the second embodiment, a point different from the first embodiment is mainly described, and the explanation of the contents overlapping with the first embodiment is omitted accordingly.

FIG. 5 is a view showing an example of an electric power business operator server, an aggregator server, a vehicle, and an information providing apparatus according to the second embodiment.

An aggregator server 2b has a function similar to the aggregator server 2a according to the first embodiment. The aggregator server 2b includes an information providing apparatus 4b.

As shown in FIG. 5, the information providing apparatus 4b includes a communication part 41b, a generation part 42b, an acquisition part 43b, and a providing part 44b.

The communication part 41b receives the vehicle position data from the vehicle 3a. The vehicle position data is, for example, data indicating a latitude and longitude of the present position of the vehicle 3a.

The generation part 42b generates cost data indicating a cost required for the vehicle 3a to move to the electric power purchase facility on the basis of the vehicle position data received by the communication part 41b and the electric power purchase facility position data accessible by the aggregator server 2b.

The acquisition part 43b acquires the cost data and electric power purchase price data. Specifically, the acquisition part 43b acquires the cost data from the generation part 42b and acquires the electric power purchase price data from the communication part 41b.

The providing part 44b provides information in which the cost indicated by the cost data and the electric power purchase price indicated by the electric power purchase price data are associated with each other.

The information providing apparatus 4b according to the second embodiment is described above. The information providing apparatus 4b provides advantages similar to the information providing apparatus 4a according to the first embodiment.

### Third Embodiment

An information providing apparatus according to a third embodiment will be described with reference to FIG. 6. The information providing apparatus according to the third embodiment differs from the information providing apparatus 4a according to the first embodiment and the information providing apparatus 4b according to the second embodiment in that the information providing apparatus according to the third embodiment is not independent and is included in a vehicle. Therefore, in the third embodiment, a point different from the first embodiment and the second embodiment is mainly described, and the explanation of the contents overlapping with the first embodiment and the second embodiment is omitted accordingly. FIG. 6 is a view showing an example of an electric power business operator server, an aggregator server, a vehicle, and an information providing apparatus according to the third embodiment.

A vehicle 3c includes a car navigation device 31c. The car navigation device 31c is similar to the car navigation device 31a according to the first embodiment. The vehicle 3c includes an information providing apparatus 4c.

As shown in FIG. 6, the information providing apparatus 4c includes a communication part 41c, a generation part 42c, an acquisition part 43c, and a providing part 44c.

The communication part 41c receives vehicle position data and receives electric power purchase facility position data. Specifically, the communication part 41c transmits the vehicle position data generated by the car navigation device 31c to an aggregator server 2a and receives the electric power purchase facility position data and the electric power purchase price data from the aggregator server 2a.

The generation part 42c generates cost data indicating a cost required for the vehicle 3c to move to the electric power purchase facility on the basis of the vehicle position data generated by the car navigation device 31c and the electric power purchase facility position data received by the communication part 41c.

The acquisition part 43c acquires the cost data and electric power purchase price data. Specifically, the acquisition part 43c acquires the cost data from the generation part 42c and acquires the electric power purchase price data from the communication part 41c.

The providing part 44c provides information in which the cost indicated by the cost data and the electric power purchase price indicated by the electric power purchase price data are associated with each other.

The information providing apparatus 4c according to the third embodiment is described above. The information providing apparatus 4c provides advantages similar to the information providing apparatus 4a according to the first embodiment.

Although embodiments of the present invention have been described, the present invention is not limited to the embodiments described above, and various modifications and substitutions can be made without departing from the scope of the invention.

What is claimed is:

1. An information providing apparatus comprising:
an acquisition part that acquires cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and
a providing part that provides information in which the cost indicated by the cost data and the electric power purchase price indicated by the electric power purchase price data are associated with each other.

2. The information providing apparatus according to claim 1,
wherein the providing part adds at least one of a ranking of the cost and a ranking of the electric power purchase price to the information and provides the information.

3. The information providing apparatus according to claim 1,
wherein the providing part provides the information of the electric power purchase facility located at a position where a path from the position indicated by the vehicle position data is equal to or less than a predetermined length.

4. The information providing apparatus according to claim 1, further comprising
a communication part that transmits the vehicle position data and receives the electric power purchase facility position data.

5. An information providing method comprising:
by way of a computer, acquiring cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and
by way of the computer, providing information in which the cost indicated by the cost data and the electric power purchase price indicated by the electric power purchase price data are associated with each other.

6. A non-transitory computer-readable recording medium including a program that causes a computer to:
acquire cost data derived based on vehicle position data indicating a position of a vehicle and electric power purchase facility position data indicating a position of an electric power purchase facility, the cost data indicating a cost required for the vehicle to move to the electric power purchase facility, and electric power purchase price data indicating an electric power purchase price at the electric power purchase facility; and
provide information in which the cost indicated by the cost data and the electric power purchase price indicated by the electric power purchase price data are associated with each other.

7. The information providing apparatus according to claim 2,
wherein the providing part provides the information of the electric power purchase facility located at a position where a path from the position indicated by the vehicle position data is equal to or less than a predetermined length.

8. The information providing apparatus according to claim 2, further comprising
a communication part that transmits the vehicle position data and receives the electric power purchase facility position data.

9. The information providing apparatus according to claim 3, further comprising
a communication part that transmits the vehicle position data and receives the electric power purchase facility position data.

10. The information providing apparatus according to claim 7, further comprising
a communication part that transmits the vehicle position data and receives the electric power purchase facility position data.
